(19) United States
(12) Patent Application Publication
(10) Pub. No.: US 2012/0191514 A1
(43) Pub. Date: Jul. 26, 2012

(54) SYSTEMS METHODS AND COMPUTER PROGRAM PRODUCTS FOR OPTING INTO MERCHANT ADVERTISING USING MOBILE COMMUNICATION DEVICE

(75) Inventors: Colin J. Roper, San Francisco, CA (US); Christian G. Dalit, San Francisco, CA (US); Terry R. Hicks, San Mateo, CA (US)

(73) Assignee: INTUIT INC., Mountain View, CA (US)

(21) Appl. No.: 13/014,487

(22) Filed: Jan. 26, 2011

(51) Int. Cl. G06Q 30/00

(52) U.S. Cl. 705/14.4

(57) ABSTRACT

Requesting and distributing electronic advertisements including electronic coupons and sales advertisements. A user of a mobile communication device such as a Smartphone views a current electronic advertisement of a merchant on a screen of the mobile communication device. After viewing the current electronic advertisement, the user wants to opt in to receive more electronic advertisements from the merchant and launches an application on the mobile communication device or accesses a software program. The application or program generates a request to receive additional electronic advertisements from that particular merchant. In response, additional electronic advertisements are provided to the user, e.g., through an intermediate computer and interfaces with a merchant computer or other source of electronic advertisements of the merchant. In this manner, merchant advertisements receive interested and targeted consumers who are able to receive electronic advertisements from a selected merchant without registering or providing personal information to the selected merchant.

### BACKGROUND

Merchants have distributed coupons and advertising materials to consumers for many years. One known method of distributing coupons is to include printed coupons within advertisement flyers that are mailed to consumers as part of a newspaper or other publication. Mass mailing methods, however, have significant shortcomings including the requirement that consumers know about or actually read printed coupons, take the time to clip printed coupons, organize printed coupons, don't lose the coupons that were collected or clipped, and have printed coupons when they are shopping. Further, even if printed coupons are redeemed, they may be redeemed on a one-time or random basis, and merchants have no ability or only very limited abilities to maintain or re-establish connections with consumers to encourage repeat purchases by consumers. Moreover, redemption rates of printed coupons are very low, e.g., on the order of 1% according to some estimates. These substantial shortcomings, very low redemption rates, consumer inconvenience and printing, mailing and distribution costs have driven merchants to offer electronic coupons that may be transmitted in an electronic mail message or text or Short Message Service (SMS) message to a consumer's mobile communication device. It is estimated that redemption rates of electronic or mobile coupons is 5-20%, substantially higher than printed coupons.

In certain known mobile coupon systems, consumers are required to register with a merchant by providing personal and/or contact information such as name, electronic mail address or cellular telephone or SMS information, which is used by the merchant to send electronic or mobile coupons to the consumer, e.g., to a cellular telephone or Smartphone such as an IPHONE, IPOD TOUCH, ANDROID, BLACKBERRY. For example, shoppers wanting to receive coupons from TARGET register at TARGET's on-line or mobile websites or by sending a text message to a designated TARGET number. Once registered, TARGET shoppers receive mobile offers or coupons only from TARGET in the form of text messages sent to their mobile communication device. A mobile coupon displayed on a screen of the mobile communication device may be redeemed to receive a discount or other benefit by entering mobile coupon data or scanning the mobile coupon at a TARGET store.

While these types of systems somewhat improve upon coupon distribution by targeting interested consumers who register with a merchant, such systems are limited in that they are merchant specific. Further, they require consumers to disclose personal and sensitive contact information, which many consumers would rather not disclose in view of risks of identity theft, fraud and spam. Additionally, if consumers want to receive offers from multiple merchants, they must register with multiple merchants such that their information is in multiple merchant systems, thus compounding these concerns and risks.

Other known systems involve a website hosted by a server that aggregates mobile coupons from various merchants. Customers can review the mobile coupons using a browser on their mobile communication devices. For example, mobilecoupon.com provides a website that provides access to mobile coupons of multiple merchants. Mobilecoupon.com and YOWZA!! also provide a mobile application that can be downloaded to a mobile communication device to search for and view mobile coupons of merchants. During use of such systems, the consumer can enter search criteria such as a zip code or the consumer's location is determined such that mobile coupons of merchants within the consumer's area are displayed. A displayed mobile coupon can be scanned or data of the displayed coupon can be entered at checkout of a merchant store to redeem the coupon and receive a discount or benefit.

While mobile coupon systems provide consumers with the ability to search for various coupons from various merchants, they may nevertheless require consumers to disclose personal and sensitive contact information to merchants. Further, since consumers have access to many electronic advertisements from various merchants and may view many coupons from many merchants at a given time, it can be difficult for merchants to capitalize on the few seconds during which a consumer views a mobile coupon and has an interest in a merchant and to maintain or re-establish connections with consumers who utilize mobile coupons.

For example, after a transaction involving a mobile coupon redeemed by a consumer at a merchant store, the merchant does not have a connection with the consumer who may make subsequent purchases from the same or other merchants. Subsequent consumer purchase decisions may depend in part upon availability of mobile coupons for subsequent purchases. While mobile coupons enhance consumer convenience and merchant exposure, as electronic advertisements become even more popular, consumers may be driven to consider merchants and make purchases based in part upon mobile coupon availability rather than merchant loyalty. This further complicates abilities of merchants to establish and maintain connections with consumers.

### SUMMARY

One embodiment is directed to a computer-implemented method for distributing electronic advertisements such as a mobile coupon or sales announcement. The method comprises receiving a request of a consumer or user to receive additional electronic advertisements from a particular or selected merchant who promotes a current electronic advertisement displayed on a screen of a mobile communication device. The request is generated by the user executing a mobile application or other program on or with the mobile communication device. Additional electronic advertisements of the particular merchant are determined and transmitted to the mobile communication device in response to the request.

A further embodiment is directed to a computer-implemented method for distributing electronic advertisements and comprises receiving a request to receive additional electronic advertisements from a merchant promoting a current electronic advertisement displayed on a screen of a mobile communication device. The request is transmitted from the mobile communication device through a first network and received at a first computer configured to process the request. The first computer is also in communication with a second computer of the merchant through a second network. The method further comprises determining, identifying or requesting additional electronic advertisements of the merchant with the first computer and transmitting additional electronic advertisements to the mobile communication device in response to the request without requiring the user to register with the merchant.

Yet another embodiment is directed to a computer-implemented method for distributing advertisements and comprises receiving a request to receive additional advertisements from a merchant promoting a current electronic advertisement displayed on a screen of a mobile communication device. The request is transmitted from the mobile communication device through a first network and received at a first computer configured to process the request. The first computer is also in communication with a second computer of the merchant through a second network. The method further comprises determining additional advertisements of the merchant with the first computer and sending the determined additional advertisements to the user in response to the request without requiring the user to register with the merchant.

In accordance with another embodiment is a method for requesting electronic advertisements using a mobile communication device. The method comprises viewing an electronic advertisement of a merchant displayed within a screen of the mobile communication device and executing a program such as a native application on the mobile communication device to generate a request to receive additional electronic advertisements from the merchant. The program transmits the request from the mobile communication device through a first network to a computer configured to process the request such that the user receives additional electronic advertisements without having to register with a merchant and provide personal or sensitive information to the merchant.

A further embodiment is directed to methods for distributing electronic advertisements and involves an intermediate computer that is in communication between a mobile communication device and a computer comprising requested electronic advertisements of a selected merchant. In such embodiments, a request for electronic advertisements of the selected merchant is received from the intermediate computer at the second computer of the selected merchant. The selected merchant was selected based at least in part upon a user request generated using a mobile communication device. The request was generated while an electronic advertisement of the selected merchant was displayed on a screen of the mobile communication device, and a program, such as a native application on the mobile communication device, was executed to allow the user to opt in to receiving additional electronic advertisements from that merchant. The method further comprises transmitting additional electronic advertisements from the second computer to the intermediate computer in response to the request.

Thus, with certain embodiments, electronic advertisements, are provided to the user (directly from a merchant or indirectly through the first, intermediate computer), and while the merchant is providing the advertisements to an interested user, the merchant may or may not know the name or contact information of the user depending on, for example, whether the merchant distributes the additional electronic advertisements directly or indirectly to the user.

Other embodiments are directed to systems and computer program products for requesting and/or distributing electronic advertisements. One system embodiment comprises a mobile communication device, a computer in communication with the mobile communication device and a program, such as a native application, executable by the mobile communication device. According to certain embodiments, the mobile communication device is configured to display a current electronic advertisement of a merchant on a screen of the mobile communication device. The program can be launched by the user such that when executed, the program generates a request for additional electronic advertisements of the merchant. The computer is configured to receive the request from the mobile communication device, determine, identify or request additional electronic advertisements of the merchant such that the additional electronic advertisements can be transmitted to the mobile communication device in response to the request. In certain embodiments, systems are operable to generate requests, search for or determine requested additional electronic advertisements, and transmit additional electronic advertisements without requiring the user to disclose personal or sensitive information such as name, address and contact information to the selected merchant.

Another embodiment is directed to a system for distributing electronic advertisements and comprises a mobile communication device, a program such as a native application that is executable by the mobile communication device, a first computer in communication with the mobile communication device through a first network and with a second computer of a merchant through a second network. Electronic advertisements of the merchant at the second computer can be received at or accessed by the first, intermediate computer. The mobile communication device is configured to display a current electronic advertisement of a merchant to a user of the mobile communication device. The program or application is executable to generate a request for additional electronic advertisements of the merchant, and the first, intermediate computer is configured to receive the request and determine which, if any, additional electronic advertisements of the same merchant are available for distribution. Any additional electronic advertisements can be transmitted to the mobile communication device in response to the request while the user is not required to register with the merchant.

Yet another embodiment is directed to a system for distributing advertisements and comprises a mobile communication device, a program or application executable by the mobile communication device, a first, intermediate computer in communication with the mobile communication device and a second computer of a merchant. The first, intermediate computer is configured to receive or access electronic advertisements of the second computer. The mobile communication device can be utilized by the user to display a current electronic advertisement on a screen of the mobile communication device. A program, such as an application downloaded to the mobile communication device, is configured to generate a request for additional advertisements of the merchant, and transmit the request. The first, intermediate computer is configured to receive the request and determine additional advertisements of the merchant such that the determined additional advertisements are sent to the user in response to the request without requiring the user to register with the merchant.

A further embodiment is directed to a system for requesting electronic advertisements and comprises a mobile communication device and a program such as an application downloaded to the mobile communication device. The mobile communication device is operable by a user to view an electronic advertisement of a merchant on a screen of the mobile communication device. The user may launch the program, which is executable by a processing element of the mobile communication device. The program is configured or operable to generate a request to receive additional electronic advertisements of the merchant and transmit the request from the mobile communication device through a first network to a computer configured to process the request.

Further embodiments are directed to computer programs or computer program products such as a mobile application, which may be downloaded to and/or accessed by the mobile communication device. When executed by a processing element of the mobile communication device, one or more instructions of the application cause the processing element to perform a process for requesting electronic advertisements. According to one embodiment the process comprises generating a request for additional electronic advertisements of a merchant promoting a current electronic advertisement displayed on a screen of the mobile communication device, and transmitting the request from the mobile communication device through a first network to a computer configured to process the request.

In a single or multiple embodiments, the current electronic advertisement that is viewed by a consumer when the request for other advertisements is generated is an electronic coupon that can be redeemed by user or a sales advertisement of the merchant.

In a single or multiple embodiments, the program or application is executed to display a visual input element, which may be selected, e.g., by a single click of the visual input element, e.g. by a single finger or stylus tap by the user, to generate the request.

In a single or multiple embodiments, additional electronic advertisements of the merchant are stored in a database of the intermediate or host computer or in a database of the second computer and accessible by the intermediate computer. Further, determined additional electronic advertisements can be transmitted indirectly from the second computer to the mobile communication device through the first computer without providing contact information of the user to the merchant, e.g., in cases in which the user does not want to register with the merchant or disclose personal or sensitive information to the merchant such that a trusted host of the intermediate computer can receive electronic advertisements from a merchant and forward them to the requesting user while the user remains anonymous with respect to the providing merchant. In another embodiments, the merchant is provide with contact information of the user such that the additional electronic advertisements can be transmitted directly from the second computer of the merchant (or another source hosting merchant advertisements) to the mobile communication device using the user's contact information.

With embodiments, interested consumers are anonymized to merchants, merchants can push offers or messages out to consumers via a single medium or combination of mediums such as SMS, e-mail, in-application, etc. Merchants are also able to segment the population of their consumers such that specific messages can be pushed to specific groups (e.g., by sending a certain message or coupon to a particular area, neighborhood or zip code). Further, merchants can receive metrics, results and analytics of the performance of their mobile coupon campaigns (e.g., how many consumers received the offer, clicked the offer, the general are where consumers are located, etc.). Merchants can also provide their own customer lists to a host of the managing or intermediate computer such that mobile coupons are sent to the anonymous consumers and those consumed identified in the list provided by merchants. These benefits are realized without requiring the user to register with the merchant such that the consumers are not required to provide sensitive or personal information such as name, address, home phone number, cellular telephone number, etc. to merchants.

### BRIEF DESCRIPTION OF THE DRAWINGS

The foregoing and other aspects of embodiments are described in further detail with reference to the accompanying drawings, wherein:

FIG. 1 illustrates a system constructed according to one embodiment for requesting to receive electronic advertisements from a particular merchant using a mobile communication device;

FIG. 2 is a flow diagram of a method for requesting to receive electronic advertisements from a particular merchant using a mobile communication device;

FIG. 3 illustrates a system constructed according to one embodiment for requesting to receive electronic advertisements from a particular merchant using a mobile communication device;

FIG. 4 illustrates one embodiment of a database of a host computer that may be utilized to process and track which users have opted in to receive electronic advertisements from certain merchants;

FIG. 5 is a flow diagram of another method for opting in to receive electronic advertisements from a merchant using a mobile communication device;

FIGS. 6A-B illustrate how an application on a mobile communication device may be executed during display of an electronic advertisement to request to receive additional electronic advertisements from a particular merchant;

FIG. 7 illustrates one example of how a database may be updated to reflect user opt-ins and available additional electronic advertisements;

FIGS. 8A-B illustrate communications between system components of various embodiments in which FIG. 8A shows how a coupon is provided from an intermediate computer to a mobile communication device to protect personal and contact information of the user, and FIG. 8B shows how a coupon is provided directly from a merchant to a mobile communication;

FIGS. 9A-C illustrate how embodiments may involve different numbers of users or consumers and merchants, wherein FIG. 9A illustrates how a single user may opt in to receive electronic advertisements from multiple merchants, FIG. 9B illustrates how multiple users may opt in to receive electronic advertisements from the same merchant, and FIG. 9C illustrates multiple users may opt in to receive respective electronic advertisements from respective merchants;

FIG. 10 illustrates how embodiments may be configured to be location-based such that whether electronic advertisements identified according to prior opt-in requests are displayed depends in part upon a location of the user; and

FIG. 11 is a system diagram of components of a computing apparatus that may be utilized by various system components.

### DETAILED DESCRIPTION OF ILLUSTRATED EMBODIMENTS

Certain embodiments relate to systems, methods and computer program products such as downloadable mobile applications utilized to request electronic advertisements on behalf of consumers and/or distribute electronic advertisements to consumers. With embodiments, a consumer utilizes a mobile communication device to view an electronic advertisement such as a coupon or sales announcement of a particular merchant and opt in to receive additional electronic advertisements from that merchant. Additional electronic advertisements of the merchant are transmitted to the mobile communication device in response to the request without requiring the consumer to register with the merchant or disclose personal or contact information to the merchant. Thus, embodiments are mutually beneficial to consumers and merchants since consumers are able to receive electronic advertisements that are of interest to the consumer and merchants increase their electronic coupon distribution to interested consumers. These mutual benefits are achieved while allowing consumers to retain their anonymity with respect to merchants by not registering with merchants or providing personal information to merchants.

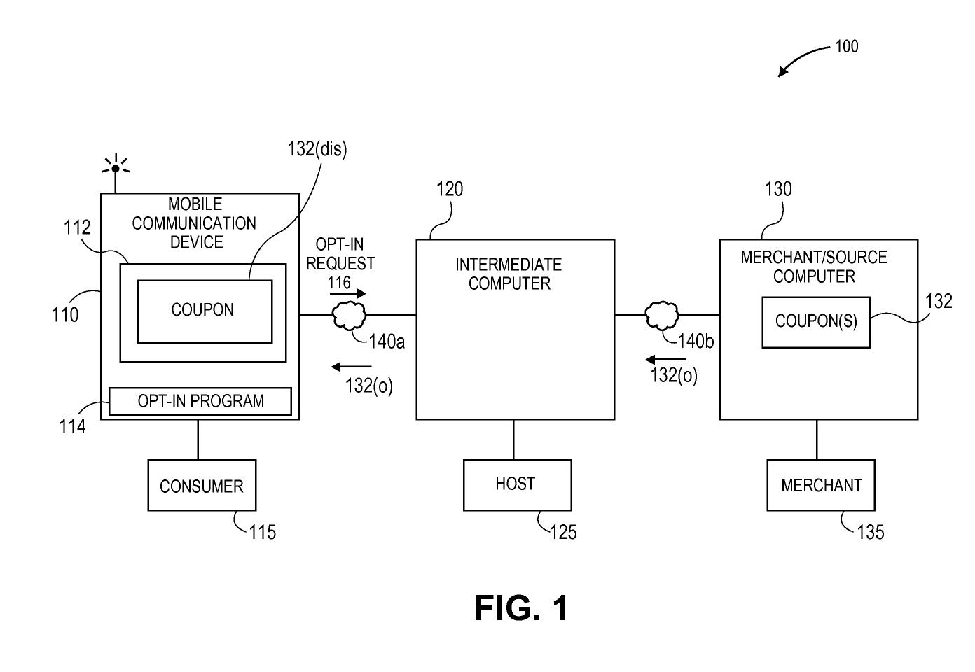

Referring to FIG. 1, one embodiment of a system 100 for requesting or distributing electronic advertisements 132 includes or involves a mobile communication device 110 of a user or consumer 115 (generally, “consumer 115”), a computer 120 of a host or intermediary 125 such as Intuit Inc. or other host, and a computer 130 of a source of electronic advertisements 132 or a merchant 135 (generally, merchant 135) that distributes electronic advertisements 132.

An electronic advertisement 132 is defined herein as including an electronic or mobile coupon and an electronic sales advertisement. For ease of explanation, reference is made generally to an electronic coupon 132, but embodiments may be utilized to allow consumers 115 to request to receive various types of electronic advertising materials.

Mobile communication device 110 is defined to include cellular telephones, Smartphones such as an IPHONE, IPOD TOUCH, ANDROID, BLACKBERRY and other mobile communication devices 110 such as a laptop computer, a Personal Digital Assistant (PDA), a computing tablet such as an IPAD and other mobile communication device 110 capable of wireless or cellular communications with intermediate computer 120 and displaying an electronic coupon 132(dis). For ease of explanation, reference is made generally to mobile communication device 110.

In certain embodiments, intermediate computer 120 may store electronic coupons 132 of various merchants 135 or access, retrieve or receive electronic coupons 132 stored at merchant computer 130 as shown in FIG. 1. Thus, intermediate computer 120 may interface with merchant computer 130 or other source of electronic advertisements of the merchant (not shown in FIG. 1) and mobile communication device 110. According to embodiments, an opt-in software program resides on mobile communication device 110 (as shown in FIG. 1) or is hosted by intermediate computer 120 or another computer (not shown in FIG. 1) and can be downloaded from intermediate or other computer through a network 140. For ease of explanation, in certain embodiments, reference is made to an opt-in software program 114 hosted by intermediate computer 120, but it will be understood that opt-in software program 114 may be hosted by and/or downloaded to mobile communication device 110 from other computers (not illustrated) through a network 140. Accordingly, the system 100 configuration illustrated in FIG. 1 is provided as one example of how embodiments may be implemented.

Computer 130 may, in certain embodiments, be a computer of merchant 135. In other embodiments, computer 130 may be a computer of a source, aggregator or distributor of electronic coupons 132 such as mobilecoupons.com.

Examples of networks 140a,b (generally network 140) and other networks 140 discussed herein for communications between system components include but are not limited to a Local Area Network (LAN), a Wide Area Network (WAN), Metropolitan Area Network (MAN), a wireless network, other suitable networks 140 capable of transmitting data, and a combination of such networks 140. For ease of explanation, reference is made to a network 140 generally, but it should be understood that various networks 140, combinations of networks 140 and communication systems, methods and protocols may be utilized.

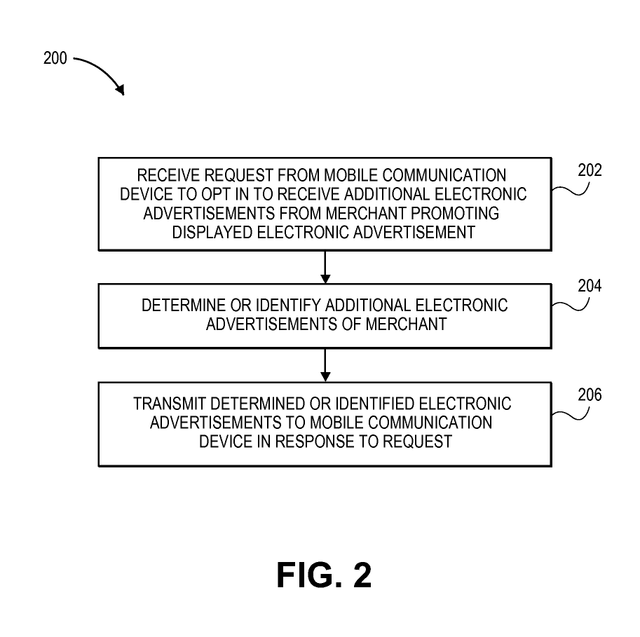

Referring to FIG. 2, and with continuing reference to FIG. 1, one embodiment of a method 200 for requesting or distributing electronic coupons 132 using system 100 components involves consumer 115 viewing a current electronic coupon 132(dis) displayed (“dis” indicating “displayed”) on a screen 112 of mobile communication device 110. If consumer 115 wants to receive other or additional electronic coupons 132(o) (“o” indicating “other” or additional electronic coupons) from that particular or selected merchant 135(s) (“s” indicating “selected” merchant), at step 202 of FIG. 2, opt-in software program 114 of FIG. 1 is executed to generate a request 116 that is transmitted from mobile communication device 110 to intermediate computer 120 to opt in to receive additional electronic coupons 132a from selected merchant 135(s). In response, at step 204, a processor or software program of intermediate computer 120 of FIG. 1 identifies other electronic coupons 132(o) of merchant 135 using, for example, merchant 135 identification data within request based at least in part upon data of the displayed electronic coupon 132(dis) or a database or table indicating merchants 135 into which consumer 115 has opted to receive electronic coupons 132(o). At step 206, in one embodiment as illustrated in FIG. 1, the processor or software program of intermediate computer 120 is executed to retrieve and send consumer 115 an electronic message to mobile communication device 110 containing additional electronic coupons 132(o) of the particular merchant 135.

Thus, consumers 115 benefit from embodiments by having control over electronic coupons 132 and express their merchant 135 preferences through their mobile communication device 110 rather than being mailed or spammed with offers that are of no interest. Merchant 135(s) benefits from embodiments by being able to capture consumer 115 interest in selected merchant 135(s) while consumer 115 is utilizing mobile communication device 110. This interest is captured as a result of a consumer-initiated link or connection between consumer 115 and selected merchant 135(s) that did not previously exist.

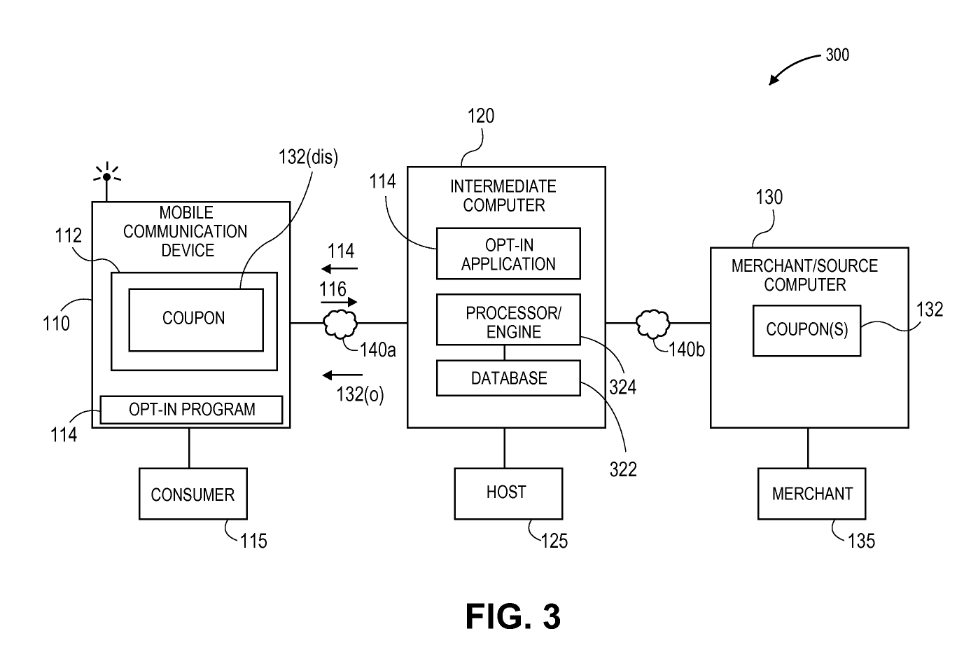

Embodiments thus provide a mutually beneficial consumer-merchant relationship even during the potentially very short period of time, e.g., a few seconds, during which consumer 115 views displayed electronic coupon 132(dis) of merchant 135(s). More particularly, embodiments are able to capture consumer 115 interest during a stage of consumer interaction with displayed electronic coupon 132(dis) at which no such capabilities previously existed in order to establish, enhance, and maintain connections with interested and actual consumers 115, even before consumers 115 visit or make a purchase from selected merchant 135(s). Further, with certain embodiments, consumers 115 are not required to register or provide personal information to merchants 135 and instead a trusted intermediate host 125 can serve as an intermediary or conduit between consumer 115 and merchant 135 to protect personal and sensitive information that consumer 115 would rather not disclose to merchant 135. Various embodiments and aspects thereof are described in further detail with reference to FIGS. 3-11.

Referring to FIG. 3, a system 300 constructed according to one embodiment includes or involves system components and participants described above including mobile communication device 110 of consumer 115, a first or intermediate computer 120 of host 125, and a second computer 130 of source or merchant 135. Embodiments may involve one or multiple merchants 135 whose respective computers 130 may be in communication with intermediate computer 120 through respective networks 140. In the illustrated embodiment, an intermediate computer 120 communicates with a computer 130 of merchant 135.

In the embodiment illustrated in FIG. 3, intermediate computer 120 hosts opt-in program 114 in the form of an application (hereafter, “opt-in software program” or “opt-in application” 114) that can be downloaded to mobile communication device 110. In other embodiments, application 114 is hosted by and downloaded from another computer (not shown in FIG. 3) and may be included in a collection of downloadable applications such as the Appstore of Apple Inc. or other collection or database of applications that can be downloaded to an IPHONE, IPAD, and IPODTOUCH, or other mobile communication device 110. Further, while embodiments are described with reference to an opt-in software program 114 in the form of a downloadable application, embodiments may also be implemented using a website or web element accessible by a browser executing on mobile communication device 110. Examples of browsers that may be utilized for this purpose include, but are not limited to, INTERNET EXPLORER, NETSCAPE NAVIGATOR, FIREFOX and SAFARI. For ease of explanation, reference is made to opt-in program 114 in the form of a mobile application that can be downloaded to and executed on mobile communication device 110.

In the embodiment illustrated in FIG. 3, intermediate computer 120 hosts a database 322 or can access a database 322 hosted by another computer (not shown in FIG. 3) through a network 140. According to embodiments, database 322 may include data such as identities of selected merchants 135(s) that were the subject of opt-in requests 116 by consumers 115, consumer 115 contact information and additional or other electronic coupons 132(o) of selected merchants 135(s) that are available to be transmitted to mobile communication device 110.

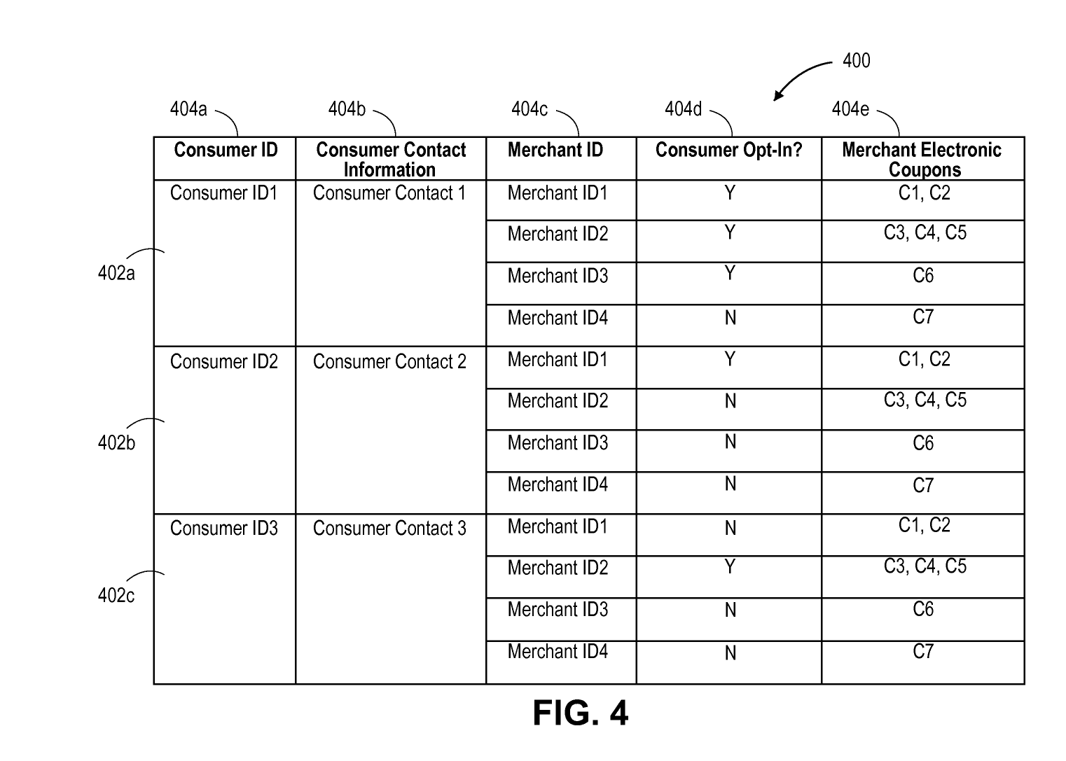

For example, referring to FIG. 4, in one embodiment, database 322 may have a table 400 or other data structure with data of consumers 115 and merchants 135 (e.g., three consumers 115a-c and four merchants 135a-d). In the illustrated embodiment, table 400 includes rows 402a-c for each consumer 115 (Consumers 1-3) and columns 404a-e with consumer identification (ID) data (e.g., consumer name, identifier or code identifying consumer), consumer contact information (e.g., residence address, facsimile number, electronic mail address, mobile phone number), merchant identification (ID) data (e.g., name, identifier or code identifying merchant) (Merchants 1-4 are identified), an indication (e.g., “Y/N”) of whether consumer 115 has opted in to receive additional or other electronic coupons 132(o) from a merchant 135, and available electronic coupons 132 that are available to be distributed which, as shown in the embodiment illustrated FIG. 4, are available electronic coupons of each merchant. In the illustrated example, Merchant 1 is offering Coupons C1, and C2), Merchant 2 is offering Coupons C3-5, Merchant 3 is offering Coupon C6, and Merchant 4 is offering Coupon C7. It should be understood that database 400 may include various types of data for different numbers of consumers 115 and merchants 135 and other numbers and various types of electronic coupons 132.

Referring again to FIG. 3, intermediate computer 120 also hosts a controller, processor or engine 324 (generally, “engine”) that is programmed or configured with software, hardware or a combination thereof, to communicate with mobile communication device 110 to receive a request for mobile coupons 132, determine and track which merchants 135 were requested with a database 322, and to retrieve or access mobile coupons 132 that are transmitted to mobile communication device 110.

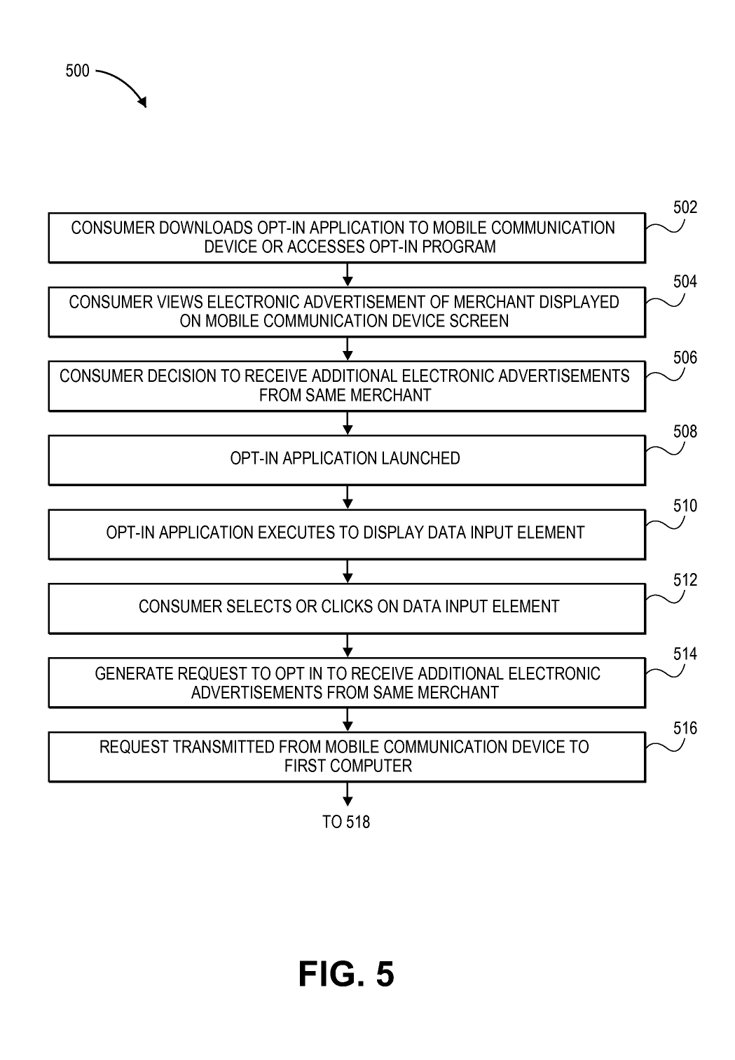

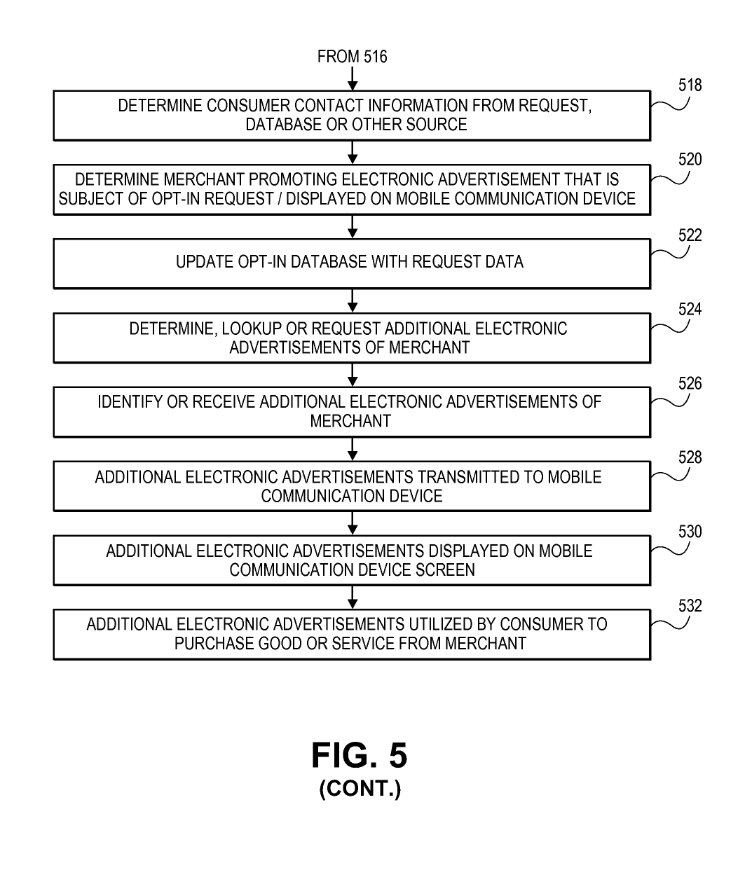

Referring to FIG. 5, one embodiment of a method 500 for requesting or distributing electronic coupons 132 using system embodiments comprises, at 502, consumer 115 downloading opt-in application 114 from intermediate computer 120 or other source to mobile communication device 110. According to certain embodiments, consumer 115 initially executes application 114 to register with host 125 of intermediate computer 120 by providing, for example, name and contact information, which is stored in table 400 of database 322 as shown in FIG. 4.

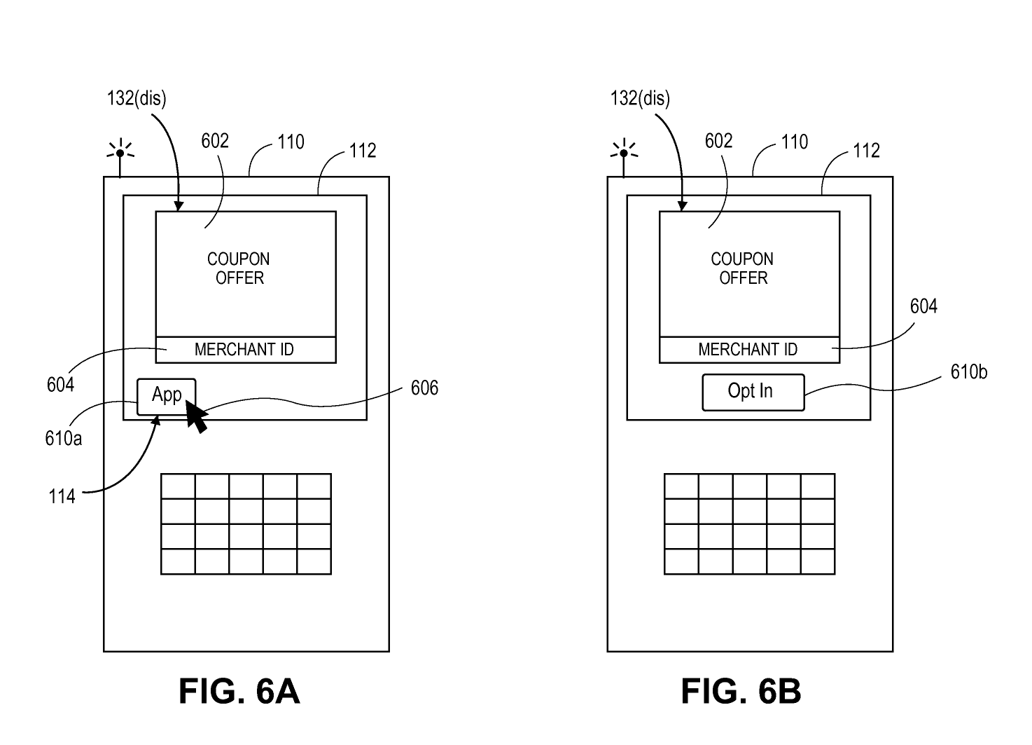

With further reference to FIG. 6A, at 504, consumer 115 views electronic coupon 132(dis) displayed on screen 112 of mobile communication device 110. As generally illustrated in FIG. 6A, electronic coupon 132(dis) includes an offer 602 (e.g., $10 off a purchase a particular item, $10 off a $50 purchase, buy 1 get 1 free, 20% off, etc.) and an identifier 604 of merchant 135 whose electronic coupon 132(dis) is displayed. Merchant identifier 604 may also be included in offer 602 and/or within another part of electronic coupon 132(dis) that may or may not be displayed to consumer 115, e.g., within a pre-determined field, tag, metadata, etc.

Electronic coupon 132(dis) that is displayed may be accessed or downloaded by consumer 115 from various known sources. For example, consumer 115 may have downloaded an electronic coupon application to mobile communication device 110 to search for mobile coupons, the result of which was the displayed electronic coupon 132. As another example, consumer 115 may have downloaded a location-based service application such as FOURSAWARE or GOWALLA and is presented with a relevant electronic coupon for the merchant 135 into which consumer 115 has checked-in electronically. As a further example, consumer 115 may utilize a news application and see a banner ad and clicks on the ad to display electronic coupon 132(dis). It will be understood that consumer 115 may download or access and view electronic coupon 132(dis) using various known sources, systems and methods, and that the above examples of systems and methods are provided as non-limiting examples of how electronic coupon 132(dis) may be displayed on mobile communication device 110.

Referring again to FIG. 5, and with further reference to FIGS. 6A-B, at 506, user 115 decides to opt in to receive additional or other electronic coupons 132(o) from the same or selected merchant 135(s) that is promoting displayed electronic coupon 132(dis), and for this purpose, launches application 114 at 508 (launching represented as pointer 606 to “App” in FIG. 6A).

According to one embodiment, opt-in application 114 executes in the background on mobile communication device 110 such that when electronic coupon 132(dis) is detected by opt-in application 114, at 510, a visual data input element 610 (e.g., in the form of an icon 610a representing application 114 as shown in FIG. 6A or an “opt in” button 610b generated by application 114 as shown in FIG. 6B is displayed on screen 112. In the illustrated embodiment, electronic coupon 132(dis) and data input element 610 are displayed on screen 112 simultaneously and separately of electronic coupon 132(dis), but in other embodiments, data input element 610 may be displayed as being overlaid onto a portion of electronic coupon 132(dis).

At 512, consumer 115 selects or clicks on data input element 610, resulting in generation of a request 116 to opt in to receive additional or other electronic coupons 132(o) from merchant 135(s) at 514. According to one embodiment, request 116 is generated in response to a single click of data input element 610a or 610b by consumer 115

According to another embodiment, with continuing reference to FIGS. 5 and 6A-B, opt-in application 114 does not execute in the background such that when consumer 115 decides to generate a request 116 to receive additional or other electronic coupons 132(o) from the same merchant 135(s), at 506, consumer 115 launches opt-in application 114 by selecting or clicking on icon 610a (e.g., as shown in FIG. 6A) which results in display of data input element 610b (e.g., as shown in FIG. 6B) at 510. At 512, consumer 115 selects or clicks on data input element 610b (FIG. 6B) to generate request 116 to opt in to receive additional or other electronic advertisements 132(o) from merchant 135(s) at 514. According to one embodiment, once application 114 is launched to generate data input element 610b (FIG. 6B), request 116 is generated in response to a single click of data input element 610b (FIG. 6B).

Referring again to FIG. 3 and with continuing reference to FIG. 5, having generated the request 116 with one or multiple clicks of a data input element 610, at 516, request 116 is transmitted from mobile communication device 110 to intermediate computer 120. Request 116 may be transmitted using different communication methods and protocols including, for example, as an electronic mail message, a text or SMS message or cellular communications.

At 518-520, engine 324 of intermediate computer 120 receives request 116, reads data of request 116, determines information about consumer 115 who sent request 116, e.g., identity and contact information of consumer 115, and determines the identity of merchant 135(s) promoting electronic coupon 132(dis) that is the subject of request 116.

For these purposes, engine 324 may, for example, read data of the identity of merchant 135(s) (e.g., by reading merchant ID field, tag, metadata or other merchant identification data element 604 of electronic coupon 132(dis)) and the identity of consumer 115 (e.g., name, phone number, phone ID, e-mail address and/or other identifying or contact information) from request 116 if application 114 is so configured. Consumer identification data may be determined from data provided to host 125 when consumer 115 registered with host and by searching database 322. Further, such information may be retrieved from other computers (not shown) of other members of an electronic coupon network that provide electronic coupons 132 to intermediate computer 120 and with whom consumer 115 has already registered. Thus, in the even that engine 324 cannot determine consumer 115 identification data based on available resources, engine 324 may request other identification data from other sources.

At 522, having identified consumer 115 and merchant 135(s), engine 324 updates opt-in database 322 to reflect request 116, and that consumer 115 has opted in to receive additional or other electronic coupons 132(o) from selected merchant 135(s).

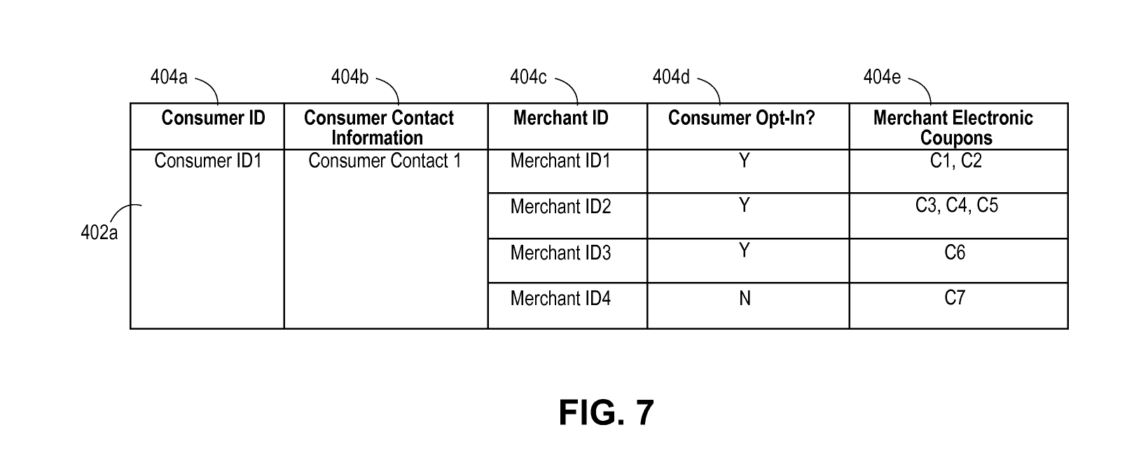

For example, referring to FIG. 7 (row 402a of FIG. 4), a database 322 or table entry 700 for Consumer 1 may include may include columns 404a-e with data identifying the consumer 115 (“Consumer 1”), contact information of consumer 115 (e.g., Telephone 1, E-mail 1, Fax 1, Address 1), identities of merchants 135 that provide electronic coupons 132 to host 125 (four merchants are illustrated in FIGS. 3 and 7 as an example), an indication of whether Consumer 1 has opted in to receive additional coupons 132(o) from respective merchants 135, and respective additional coupons available from each merchant 135. Thus, as shown in FIG. 7, Consumer 1 has opted in to receive additional coupons 132(o) from Merchant 1, which has Coupons C1 and C2 available for distribution and from Merchant 2, which has Coupons C3, C4 and C5 available for distribution, but Consumer 1 has not opted in to receive additional electronic coupons 132 from Merchant 3 or Merchant 4.

Referring again to FIG. 5, at 524, engine 324 lookups up selected merchants 325s and respective additional or other electronic coupons 132(o) per request 116 which, in the example shown in FIG. 7, if request 116 identified Merchant 2, then engine 324 would identify Coupons C3, C4 and C5. According to one embodiment, engine 324 collects electronic coupons 132 from various merchants 135 and stores them in database 322 such that engine 324 can access electronic coupons 132 from database 322 without having to access other computers. In other embodiments, database 322 does not store electronic coupons 132 but identifies electronic coupons 132 (or only stores some electronic coupons 132) such that at 526, engine 324 requests or retrieves any additional or other electronic coupons 132(o) of selected merchant 135(s) from merchant computer 130 or another source such as another computer of electronic coupon network or a server hosting a website such as mobilecoupons.com.

Referring again to FIG. 5, at 528, identified additional or other electronic advertisements 132(o) are transmitted by engine 324 from intermediate computer 120 to mobile communication device 110 such that at 530, additional or other electronic advertisements 132(o) of selected merchant 135(s) that was the subject of request 116 are displayed on screen 112 of mobile communication device 110, and at 532, may be utilized by consumer 115 to purchase ($) a good or service (G/S) from merchant 135(s) with the displayed additional or other electronic coupon 132(o). Additional or other electronic coupons 132(o) may be transmitted to and displayed by mobile communication device 110 as they become available or application 114 may be configured to retrieve or pull additional or other electronic coupons 132 for selected merchant 135(s) from intermediate computer 120. Application 114 may also be configured to display identified electronic coupons 132(o) that were previously downloaded to mobile communication device 110 but not yet displayed. Thus, embodiments may employ pushing additional or other electronic coupons 132(o) from intermediate computer 120 (or another computer such as merchant computer 130) to mobile communication device or pulling additional or other electronic coupons 132(o) to mobile communication device 110.

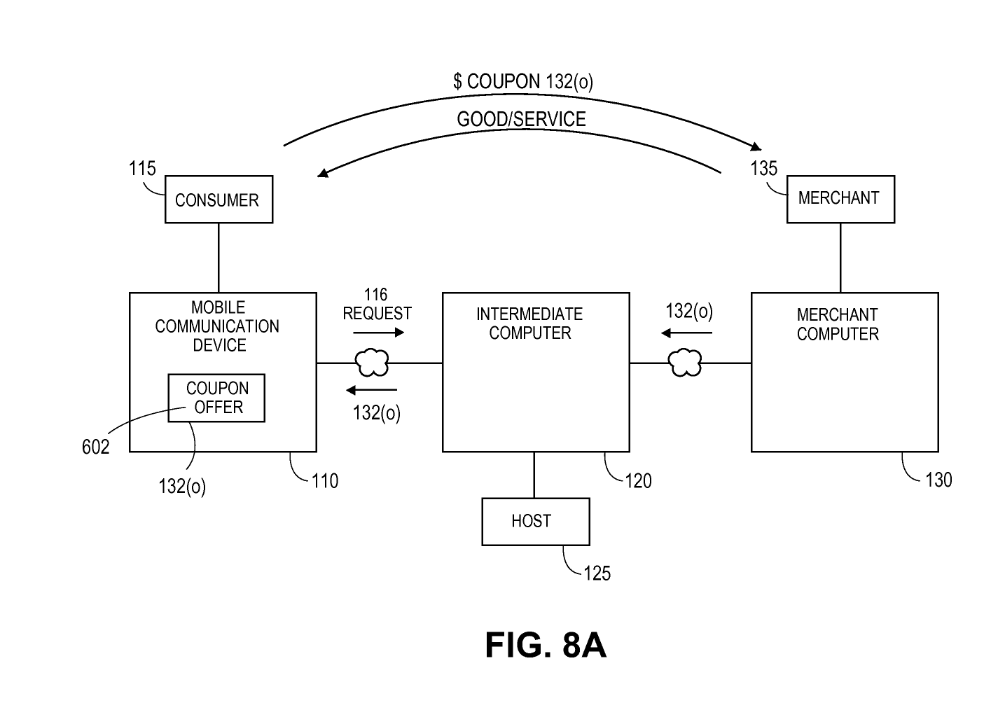

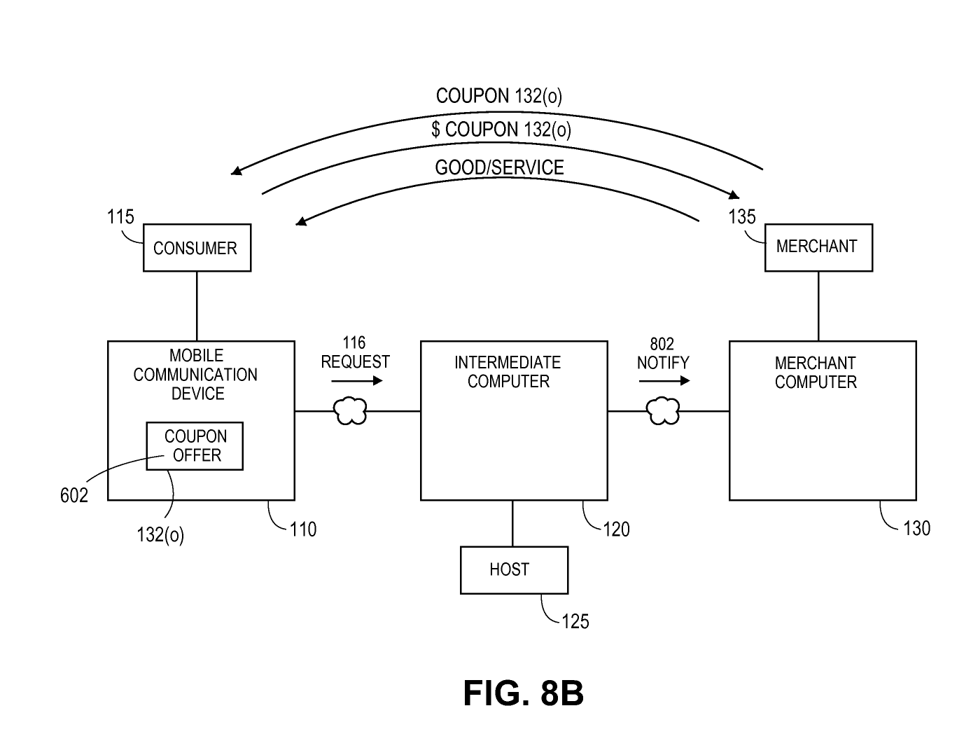

Referring to FIG. 8A, according to one embodiment, request 116 is transmitted from mobile communication device 110 to intermediate computer 120, additional coupons 132(o) are transmitted from intermediate computer 120 to mobile communication device 110, and consumer 115 may visit merchant 135(s) store to purchase a good or service with an electronic coupon 132(o) received from intermediate computer 120 according to embodiments. In this manner, consumer 115 is provided with control over which additional or other electronic coupons 132(o) are to be received, while selected merchant 135(s) offering those electronic coupons 132(o) is able to establish a connection with consumer 115 despite merchant 135(s) not knowing who consumer 115 was as a result of intermediate computer 120 serving as an intermediary between consumer 115 and merchant 135(s) such that, in contrast to various known systems and methods, consumer 115 is able to receive additional or other electronic coupons 132(o) from selected merchant 135(s) while not having to register with selected merchant 135(s) and provide personal and sensitive information to selected merchant 135(s) since such information is protected by intermediate computer 120 processing request 116.

Referring to FIG. 8B, according to another embodiment, request 116 is transmitted from mobile communication device 110 to intermediate computer 120, engine 324 notifies 802 selected merchant 135(s) of request 116 (e.g., if consumer 115 specified that contact information could be shared with merchant 135(s)), requested additional or other electronic coupons 132(o) are transmitted directly from merchant computer 130 to mobile communication device 110 (and may also be transmitted to intermediate computer 120 to allow engine 324 to update database 322 with available coupons 132 for that merchant 135(s)), and consumer 115 may visit merchant 135(s) store to purchase a good or service with an electronic coupon 132(o) received from merchant computer 130 according to embodiments.

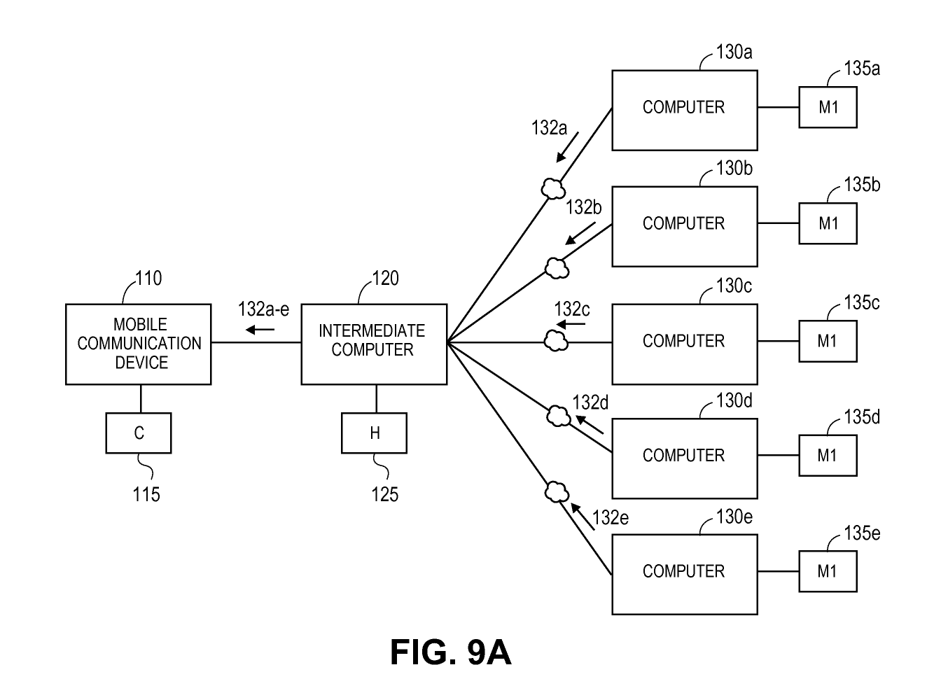

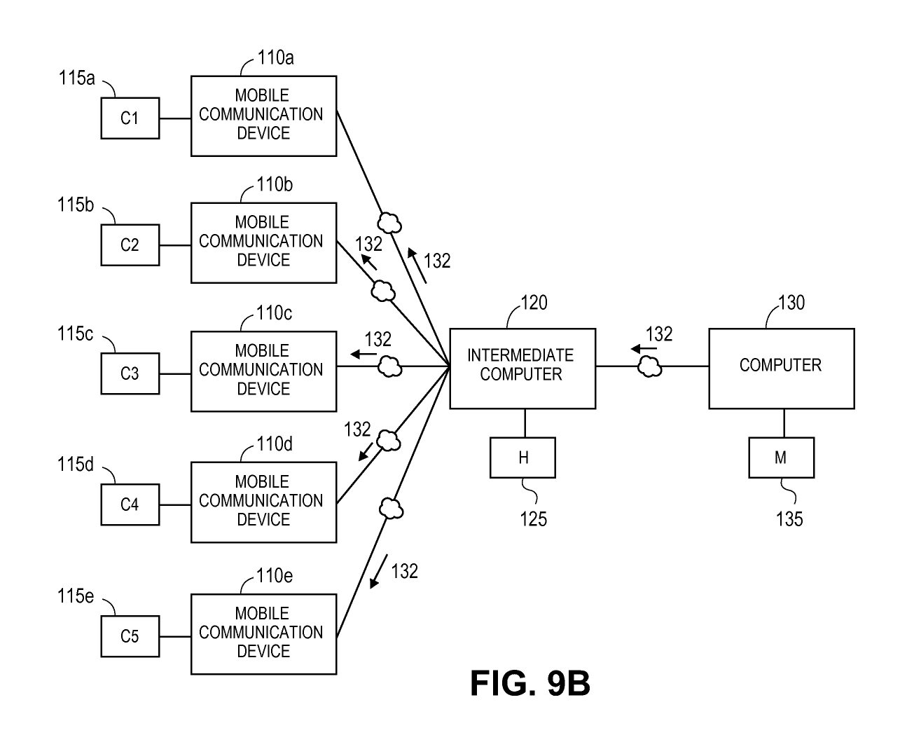

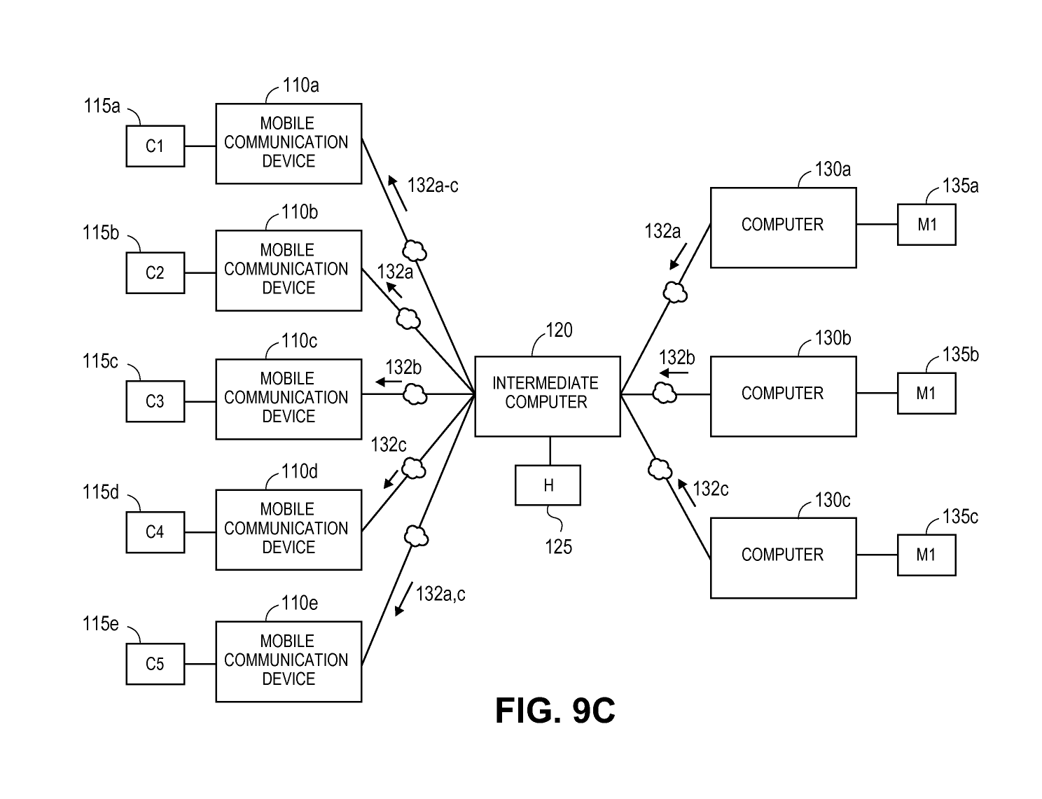

While embodiments are described above with respect to a particular consumer and merchant, embodiments may involve multiple consumers and/or multiple merchants. For example, in one embodiment, referring to FIG. 9A, and further illustrating how embodiments in which additional or other electronic coupons 132(o) are transmitted to mobile communication device 110 through intermediate computer 120 of host 125 (H) as shown in FIG. 8A may be implemented), a particular consumer 115 may have opted in to receive additional or other electronic coupons 132 from five different merchants M1-M5 135a-e such that respective additional coupons 132a-e from respective merchants 135a-e are transmitted to mobile communication device 110 through intermediate computer 120. In another embodiment, referring to FIG. 9B, five different consumers C1-5 115a-e may have each opted in to receive additional or other electronic coupons 132 from the same merchant M135 such that additional coupons 132 from that merchant 135 are transmitted to each mobile communication device 110 through intermediate computer 120. Referring to FIG. 9C, yet other embodiments may involve one, two, five, ten, hundreds, thousands and other numbers of consumers (five consumers C1-C5 115a-e are illustrated), and one, two, five, ten, hundreds, thousands and other numbers of merchants (three merchants M1-M3 135a-c are illustrated), and respective consumers 115a-e have opted in to receive additional or other electronic coupons 132 from respective merchants 135a-c. For example, FIG. 9C illustrates that consumer C1 (115a) has opted in to receive additional or other electronic coupons 132a-c from all merchants M1-3 (135a-c), consumer C2 (115b) has opted in to receive additional or other electronic coupons 132a from only merchant M1 (135a), consumer C3 (115c) has opted in to receive additional or other electronic coupons 132b from only Merchant 2 (135b), consumer C4 (115d) has opted in to receive additional or other electronic coupons 132c from only merchant M3 (135c), and consumer C5 (115e) has opted in to receive additional or other electronic coupons 132a and 132c from Merchants 1 and 3 (135a, 135c), but not Merchant 2 (135b). Accordingly, it will be understood that system and method embodiments described above are provided as illustrative examples of how embodiments may be implemented, and that embodiments may involve various numbers of consumers 115, merchants 135 or other sources of electronic coupons 132

Embodiments may also be adapted to be location-based such that additional or other electronic coupons 132 from a selected merchant 135(s) provided to consumer 115 in response to an opt-in request 116 can be updated depending on the location of consumer 115. Thus, as consumer 115 moves to different locations, additional or other electronic coupons 132 of merchants 135 at respective different locations are displayed to consumer 115 such that as consumer 115 moves, electronic coupons 132 of selected merchants 135(s) that were the subject of prior opt-in requests 116 are displayed to consumer 115 at respective locations so that consumer does not have to browse through various other electronic coupons that are not desired and instead may view electronic coupons 132(o) of previously selected or approved merchants 135(s) at respective locations. For this purpose, application 114 may be configured to monitor location or GPS data of mobile communication device 110 such that when application 114 determines that consumer 115 is at a different location, application 114 may display electronic coupons 132(o) received in response to prior opt-in requests 116 of selected merchants 135(s) in the new location or retrieve or request any such other electronic coupons 132(o) from intermediate computer 120.

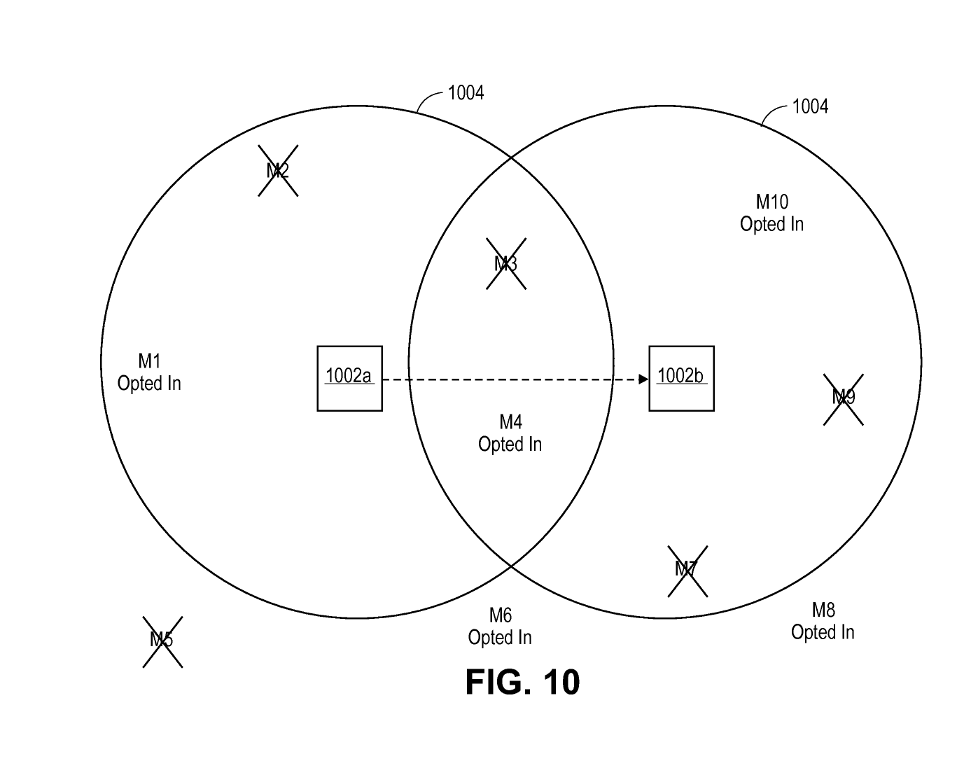

For example, referring to FIG. 10A, consumer 115 is at a first location 1002a where there are 10 merchants (M1-M10) in the displayed area. Certain merchants (M1-M4) are within a pre-defined area 1004 (e.g., defined by a distance of 0.5 mile from consumer 115, whereas other merchants (M5-M10) are outside of the pre-determined area 1004 and thus not considered for presentment to consumer 115. Of the four merchants within pre-determined area 1004, only Merchants 1-2 were the subject of prior opt-in requests 116 by consumer 115 whereas Merchants 3-4 were not. Electronic coupons 132 of selected or approved Merchants 1-2 can be displayed or consumer 115 can be alerted that such electronic coupons 132 are available for use at merchant 130 stores within pre-determined area 1004.

Referring to FIG. 10B, consumer 115 moves from first location 1002a to second location 1002b. While second location 1002b is shown as overlapping with first location 1002a, second location 1002b may or may not overlap, and that first and second locations 1002a, 1002b may be different locations within the same city, within different cities, within different states, and within different countries, e.g., depending on the pre-determined area 1004. Certain merchants (M3, M4, M7, M9-10) are within the pre-defined area 1004, whereas other merchants (M1, M2, M5 and M8) are outside of pre-determined area 1004. Of the five merchants within pre-determined area 1004, only Merchants 4 and 10 were the subject of prior opt-in requests 116 by consumer 115 whereas Merchants 3, 7 and 9 were not. Electronic coupons 132 of selected or approved Merchants 4 and 10 can be displayed or user can be alerted that such electronic coupons 132 are available for use at merchant 130 stores within pre-determined area 1004.

Thus, embodiments that combine consumers 115 opting in to receive electronic coupons 132 from merchants 135 and location-based restrictions and updates allow consumers 115 to be provided with electronic coupons 132 regardless of consumer location.

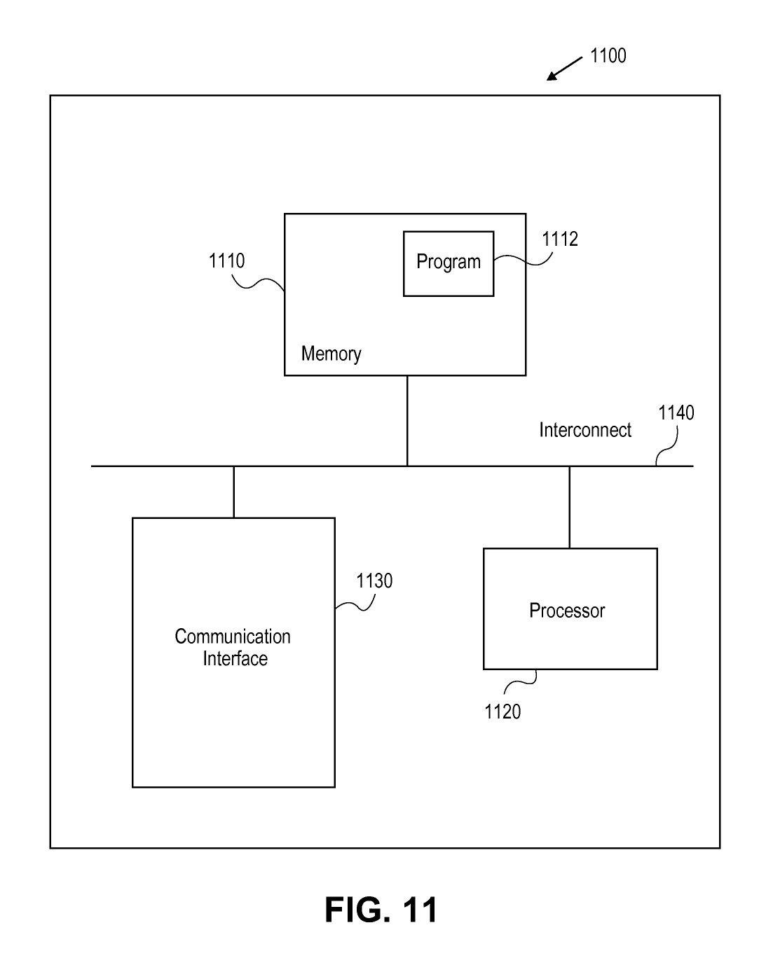

FIG. 11 illustrates how one or more or all of the system components may generally be configured to implement various method embodiments. Such system components utilized by embodiments may be, include or utilize, a personal computer system, a desktop computer, a laptop or notebook computer, a mainframe computer system, a handheld computer, a workstation, a network computer, a consumer device, a mobile phone, a personal digital assistant (PDA), a Smartphone, a PDA phone, an application server, a storage device, a peripheral device such as a switch, modem, router, or other suitable computing or communications device.

A computing device 1100 includes a memory 1110, program instructions 1112, a processor or controller 1120, a network or communications interface 1130, and connections or interconnect 1140 between such components. For example, the memory 1110 may be or include one or more of cache, RAM, ROM, SRAM, DRAM, RDRAM, EEPROM and other types of memory. Processor unit 1120 may be or include multiple processors, a single threaded processor, a multi-threaded processor, a multi-core processor, or other type of processor. Depending on the particular system component (e.g., whether the component is a computer or a hand held mobile communications device), the interconnect 1140 may include a system bus, LDT, PCI, ISA, or other types of buses, and the communications or network interface may, for example, be an Ethernet interface, a Frame Relay interface, or other interface. The network interface 1130 may be configured to enable a system component to communicate with other system components across a network 140 which, as explained above, may be a wireless or various other networks. Accordingly, the system configuration provided in FIG. 11 is provided for ease of explanation and illustration to generally illustrate system components that may be utilized in various embodiments.

Method embodiments may also be embodied in, or readable from, a computer-readable medium or carrier, e.g., one or more of the fixed and/or removable data storage data devices and/or data communications devices connected to a computer. Carriers may be, for example, magnetic storage medium, optical storage medium and magnetooptical storage medium. Examples of carriers include, but are not limited to, a floppy diskette, a memory stick or a flash drive, CD-R, CD-RW, CD-ROM, DVD-R, and DVD-RW. Processor 1120 performs steps or executes program instructions 1112 within memory 1110 and/or embodied on the carrier to implement method embodiments.

It should also be understood that the various networks 140 and associated communications interfaces described in the specification may be the same or different and may be, for example, a LAN, a WAN, a wireless and/or a cellular network. Further, it should be understood that communications between system components, including communications involving mobile communication device, intermediate computer and merchant computer, may be implemented using various networks and communication protocols and associated programming languages and may involve or utilize, by way of example, mobile applications, web browsers, HTTP, WAP, SMTP, SOAP, XML, SMS, MMS, and Java.

Further, where methods are described with respect to certain events occurring in certain order, those of ordinary skill in the art having the benefit of this disclosure would recognize that the ordering of certain steps may be modified and that such modifications are in accordance with the variations of the invention. Further, inclusion of flow diagram arrows does not imply or indicate a specific sequence.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

For example, while reference is made to an electronic advertisement or coupon, embodiments may be configured to allow a user to opt in to receive additional or other electronic coupons, additional or other electronic sales announcements and other advertising and marketing materials displayable on a mobile communication device.

Moreover, while certain embodiments are described with reference to opting in to receive additional or other electronic coupons from a particular merchant based upon an electronic coupon displayed on a mobile communication device, other embodiments may involve identifying additional coupons (whether in electronic or other form such as print) from a particular merchant based upon an electronic coupon displayed on a mobile communication device, and then transmitting or sending (e.g., by mail or other electronic methods such as facsimile) electronic and/or paper coupons to the consumer in response to the request.

Additionally, it will be understood that while certain embodiments relate to transmitting electronic coupons to a mobile communication device in response to an opt-in request, electronic coupons may also be transmitted to another type of communication device, e.g., as an e-mail to another computer or to a facsimile machine.

Method embodiments may also be embodied in, or readable from, a downloadable mobile application or an executable user element such as a widget or other input or web element utilized in a browser-based system, which is executable to send a request from a mobile communication device to indicate that a user wants to opt in to receive additional or other electronic coupons from a merchant promoting a currently displayed coupon.

It will also be understood that electronic coupons that are displayed on a mobile communication device before opt-in application is executed may be accessed or downloaded from various sources including those mentioned in this specification.

Further, while certain embodiment are described with reference to a mobile communication device with a downloadable application and an intermediate computer hosting engine and database, the engine and/or database, for example, may also be downloaded to or reside on the mobile communication device. It will be understood that application, engine and database components may be downloaded to or reside on different computing or communication devices to implement embodiments.

Additionally, certain of the steps may be performed concurrently in a parallel process when possible, as well as performed sequentially. For example, it will be understood that a user may view an electronic advertisement of merchant displayed on screen of mobile communication device and while viewing the advertisement, the user may decide to receive additional or other electronic advertisements from same merchant. As another example, an engine of intermediate computer, upon receiving an opt-in request, may determine user contact information and the identity of the merchant promoting the displayed electronic advertisement that is subject of opt-in request/displayed on mobile communication device at different times or simultaneously. Further, opt-in database updates may occur as data is received or at pre-determined times (e.g., hourly, daily or weekly).

Accordingly, embodiments are intended to exemplify alternatives, modifications, and equivalents that may fall within the scope of the claims.

What is claimed is:

1. A computer-implemented method for distributing electronic advertisements, the method comprising:
receiving a request of a user to receive additional electronic advertisements from a merchant promoting a current electronic advertisement displayed on a screen of a mobile communication device, the request being generated by the user executing an application on the mobile communication device;
determining additional electronic advertisements of the merchant; and
transmitting the determined additional electronic advertisements to the mobile communication device in response to the request without requiring the user to register with the merchant.

2. The computer-implemented method of claim 1, the current electronic advertisement comprising
an electronic coupon redeemable by the user to receive a discount on a good service purchased from the merchant, or
a sales advertisement of the merchant.

3. The computer-implemented method of claim 1, execution of the application resulting in display of a visual input element selected by the user to generate the request.

4. The computer-implemented method of claim 1, the request being generated in response to a single click of the visual input element by the user.

5. The computer-implemented method of claim 1, the request being received from a mobile communication device comprising a Smartphone, a cellular telephone or a tablet computing device.

6. A computer-implemented method for distributing electronic advertisements, the method comprising:
receiving a request to receive additional electronic advertisements from a merchant promoting a current electronic advertisement displayed on a screen of a mobile communication device, the request being transmitted from the mobile communication device through a first network and received at a first, intermediate computer configured to process the request and in communication with a second computer of the merchant through a second network;
determining additional electronic advertisements of the merchant with the first computer; and
transmitting the determined additional electronic advertisements to the mobile communication device in response to the request without requiring the user to register with the merchant.

7. The computer-implemented method of claim 6, the current electronic advertisement comprising:
an electronic coupon redeemable by the user to receive a discount on a good service purchased from the merchant, or
a sales advertisement of the merchant.

8. The computer-implemented method of claim 6, the request being received from a mobile communication device comprising a Smartphone, a cellular telephone or a tablet computing device.

9. The computer-implemented method of claim 6, the request being generated by the user executing an application on the mobile communication device.

10. The computer-implemented method of claim 9, wherein the application is first downloaded to the mobile communication device from the first, intermediate computer.

11. The computer-implemented method of claim 9, execution of the application resulting in display of a visual input element selected by the user to generate the request.

12. The computer-implemented method of claim 11, the request being generated in response to a single click of the visual input element by the user.

13. The computer-implemented method of claim 6, the additional electronic advertisements of the merchant being stored in a database on or accessible by the first, intermediate computer.

14. The computer-implemented method of claim 6, further comprising determining contact information of the user with the first computer, the determined additional electronic advertisements being transmitted indirectly from the second computer to the mobile communication device through the first computer without providing contact information of the user to the merchant.

15. The computer-implemented method of claim 6, further comprising:
determining contact information of the user with the first, intermediate computer; and
providing the determined contact information to the second computer of the merchant,
the determined additional electronic advertisements being transmitted directly from the second computer to the mobile communication device with the contact information received by the merchant.

16. A computer-implemented method for distributing advertisements, the method comprising:
receiving a request to receive additional advertisements from a merchant promoting a current electronic advertisement displayed on a screen of a mobile communication device, the request being transmitted from the mobile communication device through a first network and received at a first, intermediate computer configured to process the request and in communication with a second computer of the merchant through a second network;
determining additional advertisements of the merchant with the first computer; and
sending the determined additional advertisements to the user in response to the request without requiring the user to register with the merchant.

17. A method for requesting electronic advertisements using a mobile communication device, the method comprising:
viewing an electronic advertisement of a merchant displayed within a screen of the mobile communication device;
executing a program on the mobile communication device to generate a request to receive additional electronic advertisements from the merchant; and
transmitting the request from the mobile communication device through a first network to a computer configured to process the request.

18. The method of claim 17, the program comprising an application downloaded to the mobile communication device.

19. The method of claim 18, the application being downloaded to a mobile communication device comprising a Smartphone, a cellular telephone or a tablet computing device.

20. The method of claim 17, execution of the program generating a visual input element, the method further comprising selecting the visual input element to generate the request.

21. The method of claim 21, selecting the visual input comprising a single click of the visual input element.

22. The method of claim 17, further comprising receiving at least one additional electronic advertisement of the merchant at the mobile communication device in response to the request while not disclosing contact information of a user of the mobile communication device to the merchant.

23. A computer-implemented method for distributing electronic advertisements, the method comprising:
receiving, from a first, intermediate computer and at a second computer of a selected merchant, a request for electronic advertisements of the selected merchant, the merchant being selected based at least in part upon a request generated by a user of a mobile communication device for additional electronic advertisements of the selected merchant while an electronic advertisement of the selected merchant was displayed on a screen of the mobile communication device;
transmitting additional electronic advertisements of the selected merchant from the second computer to the first, intermediate computer in response to the request without knowing an identity of the user who requested the additional electronic advertisements.

24. A system for distributing electronic advertisements, comprising:
a mobile communication device configured to display a current electronic advertisement of a merchant to a user of the mobile communication device;
a computer in communication with the mobile communication device through a network;
a program executable by the mobile communication device and configured to generate a request for additional electronic advertisements of the merchant, the computer being configured to receive the request, determine additional electronic advertisements of the merchant, and transmit additional electronic advertisements to the mobile communication device in response to the request without requiring the user to register with the merchant.

25. The system of claim 24, the program being configured to display a visual input element that can be selected by the user to generate the request.

26. The system of claim 25, the visual program being configured such that the request is generated in response to a single click of the visual input element by the user.

27. The system of claim 24, the program comprising an application, and the mobile communication device comprising a Smartphone, a cellular telephone or a tablet computing device.

28. A system for distributing electronic advertisements, comprising:
a mobile communication device, the mobile communication device being configured to display a current electronic advertisement of a merchant to a user of the mobile communication device;
a first, intermediate computer in communication with the mobile communication device through a first network;
a second computer of a merchant in communication with the first computer through a second network, the first, intermediate computer receiving or accessing electronic advertisements of the second computer;
a program executable by the mobile communication device and configured to generate a request for additional electronic advertisements of the merchant,
the first, intermediate computer being configured to receive the request and determine additional electronic advertisements of the merchant such that the determined additional electronic advertisements are transmitted to the mobile communication device in response to the request without requiring the consumer to register with the merchant.

29. The system of claim 28, the program being configured to display a visual input element that can be selected by the user to generate the request.

30. The system of claim 29, the visual program being configured such that the request is generated in response to a single click of the visual input element by the user.

31. The system of claim 28, the program comprising an application, and the mobile communication device comprising a Smartphone, a cellular telephone or a tablet computing device.

32. The system of claim 28, the first, intermediate computer being further configured to determine contact information of the user and to have the determined additional electronic advertisements transmitted indirectly from the second computer to the mobile communication device through the first computer without providing contact information of the user to the merchant.

33. The system of claim 28, the first, intermediate computer being further configured to determine contact information of the user and to provide the determined contact information to the second computer of the merchant such that the determined additional electronic advertisements can be transmitted directly from the second computer to the mobile communication device with the contact information received by the merchant.

34. A system for distributing advertisements, comprising:
a mobile communication device, the mobile communication device being configured to display a current electronic advertisement of a merchant to a user of the mobile communication device;
a first, intermediate computer in communication with the mobile communication device through a first network;
a second computer of a merchant in communication with the first computer through a second network, the first, intermediate computer receiving or accessing electronic advertisements of the second computer;
a program executable by the mobile communication device and configured to generate a request for additional advertisements of the merchant,
the first, intermediate computer being configured to receive the request and determine additional advertisements of the merchant such that the determined additional advertisements are sent to the consumer in response to the request without requiring the consumer to register with the merchant.

35. A system for requesting electronic advertisements, comprising:
a mobile communication device operable by a user to view an electronic advertisement of a merchant displayed on a screen of the mobile communication device; and
a program executable by a processing element of the mobile communication device in response to user input, the program being configured to generate a request to receive additional electronic advertisements of the merchant and transmit the request from the mobile communication device through a first network to a computer configured to process the request.

36. A software application downloadable to a mobile communication device from a computer, the software application embodying one or more instructions which, when executed by a processing element of the mobile communication device, cause the processing element to perform a process for requesting electronic advertisements, the process comprising generating a request for additional electronic advertisements of a merchant promoting a current electronic advertisement displayed on a screen of the mobile communication device, and transmitting the request from the mobile communication device through a first network to a computer configured to process the request.
